(19) United States
(12) Patent Application Publication
(10) Pub. No.: US 2004/0148743 A1
(43) Pub. Date: Aug. 5, 2004

(54) Releasable clamp for helmet strap

(75) Inventor: Anton Brunt, Amsterdam (NL)

Correspondence Address: BROMBERG & SUNSTEIN LLP, 125 SUMMER STREET, BOSTON, MA, 02110-1618, US

(73) Assignee: Strategic Sports Ltd., Hong Kong (HK)

(21) Appl. No.: 10/354,296

(22) Filed: Jan. 30, 2003

(51) Int. Cl. F16G 11/00

(52) U.S. Cl. 24/132 WL; 24/132 R

(57) ABSTRACT

A strap clamp for e.g. a helmet includes relatively pivotable members (11) which have internal wedge faces (19). Relative pivoting movement of the members (11) releases the wedge faces to permit strap adjustment. In the preferred embodiment the pivotable members are identical, and snap-fitted together. Divergence of the straps on one side gives a degree of self-locking under tension.

### TECHNICAL FIELD

This invention relates to a releasable clamp for a helmet strap of variable length, and particularly to a clamp for the chin strap of a helmet. Such a strap typically comprises one or more strands, whose overall length and angle may be adjusted and fixed by the clamp as circumstances require.

### BACKGROUND TO THE INVENTION

Chin straps of helmets require adjustment to suit the head size and head shape of the wearer, particularly to ensure that the strap is sufficiently tight so that the helmet cannot accidentally be dislodged. A conventional safety helmet has such straps that come from the rear and the front and come together under the ear forming a “Y”. As different wearers have different head shapes and head sizes, being able to adjust both the length and angle of the location of this “Y” joint is important.

Adjustment of a chin strap is somewhat problematic because many prior art devices are awkward to use, typically requiring both hands.

The user may for example choose to adjust the length of the strap off the head, by a process of trial and error, until a comfortable fit is obtained. Once the strap is clamped at the desired length, it may be somewhat difficult to connect the usual fastener and to undo the fastener when the helmet is to be removed. There is a risk of pinching skin, which is painful.

Alternatively the user may choose to shorten the strap whilst wearing the helmet, but this requires the user to be somewhat dextrous because the clamp is out of sight. The same problems remain when the helmet is to be removed. The risk of pinching skin is also present.

What is required is a clamp which can be easily operated whilst the helmet is on the head, and which thus permits ready adjustment of the tightness of the strap according to the wearers wishes. Such a clamp should be equally suitable for left and right sides of the helmet, and suitable for left and right handed wearers. The clamp should avoid a screw since many users cannot distinguish screwing and unscrewing directions, especially when the screw is out of sight. Furthermore the device should preferably be adjustable by a gloved hand, and have a low risk of pinching.

### SUMMARY OF THE INVENTION

According to the invention there is provided a clamp for a strap of variable length, the clamp comprising a body having two relatively pivotable members defining a through passage therebetween and the through passage being adapted to receive a strap, wherein the pivotable members are relatively movable between an open condition in which the strap is loose in the passage and a closed condition in which the strap is clamped in the passage.

In a preferred embodiment the passage is substantially rectangular and adapted to receive overlying flat straps. In the preferred embodiment the pivotable members include clamp surfaces adapted to act on opposed flat surfaces of said straps by progressive reduction in the size of said passage. The clamp surfaces are preferably wedge like and are movable over one another in parallel planes at right angles to said pivot axis.

Preferably the relatively pivotable members are biased to the closed condition. Such a clamp thus grips the strap until released.

In one preferred embodiment the pivotable members have respective arms extending at an acute angle to each other in a plane perpendicular to the pivot axis, and squeezable together to the open condition. In the preferred embodiment the arms are squeezable in a first plane, at right angles to the pivot axis of the clamp, and the pivotable member includes clamp surfaces movable away from said first plane as said arms are squeezed in use, thereby to move said clamp to the open condition.

Such arms are adapted to be squeezed together by one hand in order to release the clamp. In the preferred embodiment the arms are gripped between finger and thumb for release of the clamp. In this embodiment, the arms are squeezed in a direction substantially parallel to the surface of the skin; accordingly the risk of skin pinching is reduced.

One or both pivotable members preferably includes a wedge surface on the interior surface whereby, in the closed condition the wedge surface or wedge surfaces reduce the size of said through passage. In the preferred embodiment a wedge surface is provided on each pivotable member.

Preferably the pivotable members are identical, and comprise mutually snap-fitting plastic moulding. Each snap fitting-moulding comprises a ‘C’ section member having opposed portions extending at right angles to said pivot axis, and through which said pivot axis passes. Said opposed portions preferably define circular guideways for interlocking engagement with circular guideways of a corresponding ‘C’ section member.

The strap through passage is, in the open condition, preferably just large enough to allow smooth movement of the strap therethrough. Accordingly clamping occurs almost immediately the pivotable members move from the open condition towards the closed condition.

The invention also comprises a strap assembly incorporating the aforesaid clamp. In a preferred embodiment the strap assembly comprises two flat strands passing through the clamp and overlying one another, wedge surfaces on the clamp acting on opposed flat surfaces of the overlying straps to fix the straps against movement relative to each other and to the clamp.

Preferably the two strands are arranged to diverge in use on one side of the clamp, the diverging strands bearing on arms of the clamp to urge the clamp to be the closed condition. In a preferred embodiment said arms diverge at an acute angle and are squeezable together in order to move the clamp to the open condition.

In the preferred embodiment the diverging strands are adapted for anchorage at one side of a helmet, to the front and to the rear, the clamp being positioned at one side of the face.

### BRIEF DESCRIPTION OF DRAWINGS

Other features of the invention will be apparent from the following description of a preferred embodiment shown by way of example only in the accompanying drawings, in which:

FIG. 1 is a perspective view of a clamp according to the invention and in the closed condition;

FIG. 2 corresponds to FIG. 1 and shows the clamp in the open condition;

FIG. 3 shows one half of the clamp of FIG. 1;

FIG. 4 is a plan view showing the clamp in the closed condition, with straps in outline;

FIG. 5 corresponds to FIG. 4 and shows the clamp in the open condition;

FIG. 6 is a somewhat simplified cross-section on line 6-6 of FIG. 4; and

FIG. 7 is a somewhat simplified cross-section on line 7-7 of FIG. 5.

### DESCRIPTION OF PREFERRED EMBODIMENT

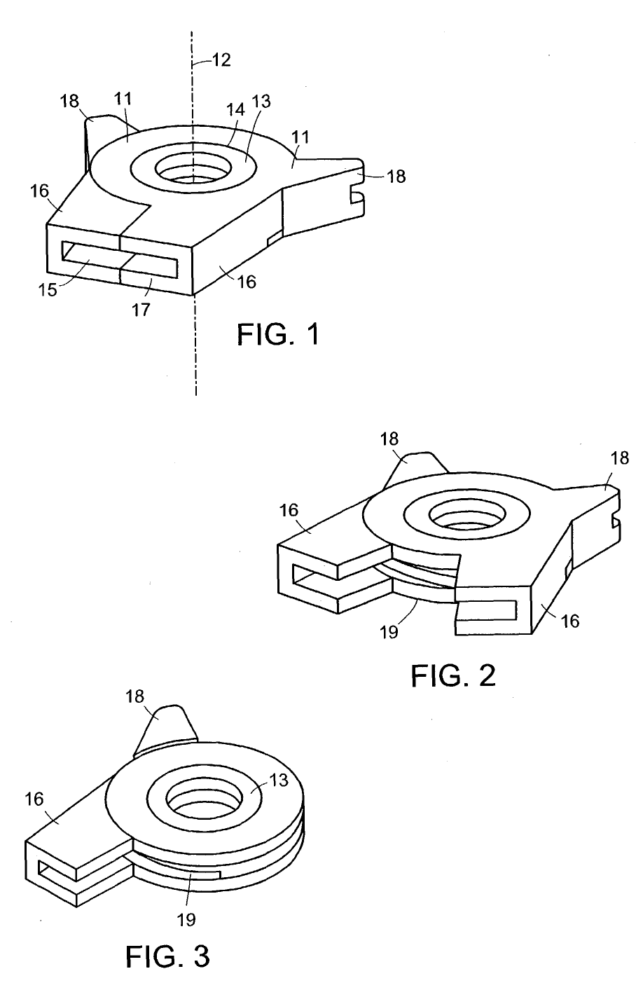

With reference to the drawings FIGS. 1-3 illustrate a clamp comprising two identical unitary plastic mouldings (11), one of which is shown in FIG. 3. The mouldings (11) are of e.g. polypropylene or other suitable plastics, and adapted to snap together about a common axis (12).

Each moulding (11) has a ‘C’ section, the central portions defining circular members. On each member one of the circular members is raised over an inner circumference (as shown in FIG. 3) whereas the other is relieved in mirror image. On assembly the raised portion (13) enters the relieved portion (14) on top and bottom to hold the mouldings together for relative arcuate movement, as will be further described.

On connection of the ‘C’ section mouldings, a through passage (15) is created.

As shown in FIG. 1 lower arms (16) of the mouldings extend from the circular members in the same direction, and abut to define a generally rectangular mouth (17) of the through passage. Upper arms (18) diverge, but may be moved together to open the mouth (17) as illustrated in FIG. 2.

Within the circular members, wedge faces (19) are defined.

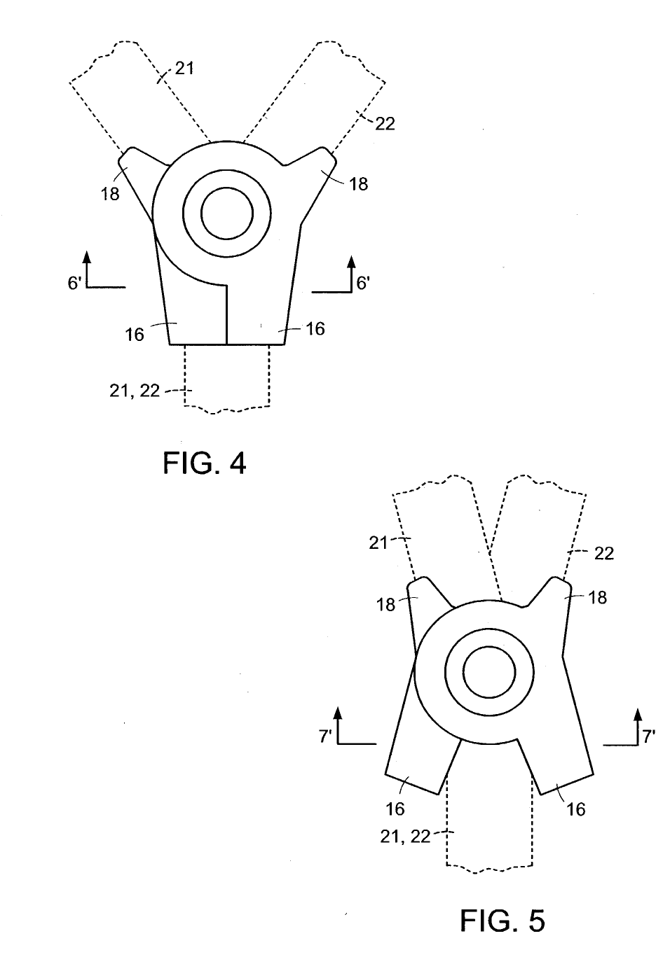

FIGS. 4 and 5 show the device in plan, and with two straps 21,22 passing through the passage 15. The straps enter on either side at the top (as viewed) and overlie each other on exit at the bottom (as viewed).

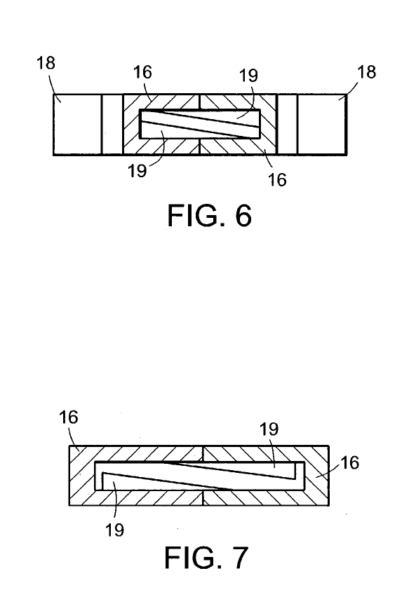

FIGS. 6 and 7 show in greater detail the opposed wedge faces 19 (the straps are omitted from FIGS. 6 and 7 to improve clarity thereof, and the sections are simplified to omit the overlapping portions of the circular members).

As illustrated in FIG. 6 the wedge faces have a certain clearance therebetween in the closed condition of the clamp. The clearance is set according to the thickness of the overlying straps so that the straps are immovably clamped against one another and the device in the closed condition of the clamp.

FIG. 7 illustrates that when the mouth 17 is opened by relative arcuate movement of the mouldings, the wedge faces (19) move apart, thus releasing the clamping force and allowing relative movement between the straps, and between the straps and the wedge faces.

The skilled man can select the appropriate wedge size and angle according to the materials of the clamp and of the straps, the relevant coefficients of friction and the forces to be resisted by the clamp. The straps are typically ribbed in order to interengage in the closed condition of the clamp.

FIGS. 4 and 5 show a typical strap arrangement for one side of a cycle helmet, the straps 21,22 being anchored at their upper ends to the front and rear parts of a helmet. The lower ends of the straps (as viewed) generally pass around the chin of the user and are anchored on the helmet at the other side.

It will be appreciated that by shortening or lengthening the upper portions of the straps 21,22, the “Y” formed with the clamp under the ears allows the helmet to rest more comfortably and more securely on the head. By shortening or lengthening one strap and not the other, the wearer can adjust the angle of the Y and thus accommodate different head shapes and sizes.

A device according to the invention can be provided on one or both sides of the helmet. If provided on one side only the other side may have a guide adapted to separate the overlying straps for attachment to corresponding front and rear helmet anchorages.

In the case of a helmet strap, it will be appreciated from FIG. 4 that the individual straps are directed to their individual anchorages and, in the closed condition of the clamp, have a tension. Movement of the clamp to the open condition, as shown in FIG. 5, increases that tension which tends to return the clamp to the closed condition unless it is moved down the overlying straps by the wearer.

It will thus be appreciated that tightening of the strap by movement of the clamp towards the helmet will inevitably introduce tension which will in turn act to urge and hold the clamp in the closed condition. Whilst this force can easily be overcome by the wearer, the clamp nevertheless exhibits a useful and sufficient self-locking property when the strap is tightened.

It will be appreciated that the strap may be of a different kind. For example the strap may be anchored to the helmet at one side and pass upwardly (as viewed) through the clamp to a helmet, via which it is guided from a front mounting to a rear mounting, and thence downwardly via the clamp to a loose end. By releasing the clamp and pulling on the loose end, the strap may be tightened to the desired degree.

It will be appreciated that the clamp is also immediately suitable for other straps, such as may be found on rucksacks or the like.

A hairpin spring or the like may be provided to urge the clamp to the closed condition. In such an arrangement self locking by divergent straps is not necessary and thus straps may overlie both when approaching and departing the clamp.

A feature of the invention is that the clamping force generated by said clamp is progressive and dependent on the clearance between the wedge faces 19. Accordingly in the case of divergent strands of the preferred embodiment, the grip of the clamp tends to increase as the strap is tightened.

The skilled man will however appreciate that the clamp of the invention can be maintained in the closed condition and/of the open condition by means of a snap fitting detent or the like, for example a protrusion of one of the circular members engageable in a detent or an aperture of the adjacent and relatively movable circular members. In the case of a detent for open and closed conditions, the lower arms (16) and upper arms (18) may be squeezed to release or engage the appropriate detent.

1. A clamp for a strap of variable length, the clamp comprising a body having two relatively pivotable members defining a through passage therebetween, and the through passage being adapted to receive at least one strand of a strap, wherein the pivotable members are relatively movable between an open condition in which said at least one strand is loose in said passage, and a closed condition in which said at least one strand is clamped in said passage.

2. A clamp according to claim 1 wherein said passage extends substantially at right angles to the pivot axis of said pivotable members.

3. A clamp according to claim 1 wherein said pivotable members are identical.

4. A clamp according to claim 3 wherein said pivotable members have a ‘C’ shaped section, the free edges overlapping to define said through passage.

5. A clamp according to claim 1 wherein said pivotable members are biased to the closed condition.

6. A clamp according to claim 1 and including at least one internal wedge surface, wherein said wedge surface reduces the size of said through passage in the closed condition of said clamp.

7. A clamp according to claim 6 wherein each of said pivotable members includes a wedge surface thereon.

8. A clamp according to claim 7 wherein said wedge surfaces at least partially overlie in the closed condition of said clamp.

9. A clamp according to claim 8 wherein said wedge surfaces lie in parallel planes.

10. A clamp according to claim 1 wherein said pivotable members each include an arm extending therefrom, said arm's being at an acute angle in the closed condition of the clamp and being squeezable together to move said clamp to the open condition.

11. A clamp according to claim 10 wherein said arms project on the same side of the pivot axis of said pivotable members.

12. A clamp according to claim 11 wherein said arms define a divergent mouth adapted to guide divergent strands of a strap for said clamp.

13. A strap assembly comprising a clamp according to claim 1 and two strands of a strap in said through passage.

14. A strap assembly according to claim 13 wherein said through passage is substantially rectangular, and said straps are flat.

15. A strap assembly according to claim 14 wherein said straps overlie.

16. A strap assembly according to claim 15 wherein said pivotable members include internal wedge faces adapted to reduce the size of said through passage in the closed condition of said clamp.

17. A strap assembly according to claim 13 and further including diverging arms, one arm on each of said pivotable members, said strands being adapted to be guided via said arms to spaced fixing locations to define one end of a strap at one side of said clamp.

18. A method of adjusting the length of a multi-strand strap, the method comprising applying a releasable clamping force to overlying strands of the strap, releasing said force, adjusting the relative strand length and reapplying said clamping force, wherein said clamping force is applied by opposed wedges movable towards one another on an axis substantially perpendicular to the direction of said overlying strands.

19. A method according to claim 18 wherein said strands are flat, and said axis is in the width direction thereof.

20. A method according to claim 18 wherein said wedges have parallel flat wedges faces.
